(19) United States
(12) Patent Application Publication
(10) Pub. No.: US 2024/0066441 A1
(43) Pub. Date: Feb. 29, 2024

(54) SYSTEMS AND METHODS FOR SEPARATION OF A FEED MATERIAL USING HYDROPHOBIC AND HYDROPHILIC MATERIALS

(71) Applicant: CarbonBridge Inc., San Jose, CA (US)

(72) Inventors: Manu Pillai, San Jose, CA (US); William Koutny, Santa Clara, CA (US)

(21) Appl. No.: 18/237,676

(22) Filed: Aug. 24, 2023

Related U.S. Application Data
(60) Provisional application No. 63/402,843, filed on Aug. 31, 2022.

(51) Int. Cl. B01D 29/11; B01D 29/01; B01D 35/26

(52) U.S. Cl. CPC B01D 29/114; B01D 29/01; B01D 35/26; B01D 2201/184; B01D 2201/202; B01D 2201/204

(57) ABSTRACT

A filter system is disclosed. In an embodiment, a filter system includes a separation layer having a plurality of apertures that allow passage of a filtrate portion of a feed material from a first side of the separation layer to a second side of the separation layer, hydrophilic material integrated with the separation layer to promote the passage of the filtrate portion of the feed material through the plurality of apertures, and hydrophobic material integrated with the separation layer to inhibit blockage of the plurality of apertures by a retentate portion of the feed material.

### BACKGROUND

Various different techniques can be used to separate components of a viscous material such as a biowaste that may include water, organic matter, and highly soluble salts. One technique for separating the water from the biowaste involves distillation/vaporization. Although distillation/vaporization is effective at separating water from biowaste, the process is energy intensive. Filtration techniques, such as reverse osmosis, can be more energy efficient, but “fouling” of the filters is a common problem.

### SUMMARY

A filter system is disclosed. In an embodiment, a filter system includes a separation layer having a plurality of apertures that allow passage of a filtrate portion of a feed material from a first side of the separation layer to a second side of the separation layer, hydrophilic material integrated with the separation layer to promote the passage of the filtrate portion of the feed material through the plurality of apertures, and hydrophobic material integrated with the separation layer to inhibit blockage of the plurality of apertures by a retentate portion of the feed material.

In an embodiment, the hydrophilic material is located on walls of the apertures.

In an embodiment, the hydrophobic material is located on a first major surface at the first side of the separation layer.

In an embodiment, the hydrophilic material is located on walls of the apertures and the hydrophobic material is located on a first major surface at the first side of the separation layer.

In an embodiment, the plurality of apertures have a diameter of 2.8 angstroms±20%.

In an embodiment, the plurality of apertures cover 1-25% of an area of the separation layer.

In an embodiment, the filter system further includes a first flow channel through which the feed material flows and a second flow channel through which the filtrate portion of the feed material flows.

In an embodiment, the filter system further includes a pump configured to apply pressure in the first flow channel.

In an embodiment, the filter system further includes a vacuum pump configured to apply a vacuum in the second flow channel.

In an embodiment, the filter system further includes a pump configured to apply pressure in the first flow channel and a vacuum pump configured to apply a vacuum in the second flow channel.

In an embodiment, the separation layer is tubular in shape.

In an embodiment, the separation layer is planar in shape.

Another embodiment of a filter system is disclosed. The filter system includes a separation layer having a plurality of apertures that allow passage of a filtrate portion of a feed material through the plurality of apertures from a first side of the separation layer to a second side of the separation layer, hydrophilic material integrated with the plurality of apertures to promote the passage of the filtrate portion of the feed material through the plurality of apertures, and hydrophobic material integrated with the separation layer on a first major surface at the first side of the separation layer to inhibit blockage of the plurality of apertures by a retentate portion of the feed material.

Another embodiment of a filter system is disclosed. The filter system includes an input to receive a feed material, outer structure, inner structure, a first output to output a filtrate portion of the feed material, a second output to output a retentate portion of the feed material, wherein the inner structure includes a separation layer having a plurality of apertures that allow passage of the filtrate portion of the feed material from a first side of the separation layer to a second side of the separation layer, hydrophilic material integrated with the separation layer to promote the passage of the filtrate portion of the feed material through the plurality of apertures, and hydrophobic material integrated with the separation layer at the first side of the separation layer to inhibit blockage of the plurality of apertures by a retentate portion of the feed material.

In an embodiment, the hydrophobic material is integrated on a first major surface of the separation layer at the first side of the separation layer.

In an embodiment, the hydrophilic material is integrated on walls of the apertures.

In an embodiment, the hydrophobic material is integrated on a first major surface of the separation layer at the first side of the separation layer and wherein the hydrophilic material is integrated on walls of the apertures.

In an embodiment, the outer structure comprises a pipe.

In an embodiment, the outer structure and the inner structure are tubular shaped.

Another embodiment of a filter system is disclosed. The filter system includes an input to receive a feed material, a tubular outer structure, a tubular inner structure, a first output to output a filtrate portion of the feed material, a second output to output a retentate portion of the feed material, wherein the tubular inner structure includes a separation layer having a plurality of apertures that allow passage of the filtrate portion of the feed material from an outer side of the separation layer to an inner side of the separation layer, hydrophilic material integrated with the separation layer to promote the passage of the filtrate portion of the feed material through the plurality of apertures, and hydrophobic material integrated with the separation layer at the outer side of the separation layer to inhibit blockage of the plurality of apertures by a retentate portion of the feed material.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts an example of a filter system that is configured to separate a feed material into a filtrate and a retentate.

FIG. 2 is a side cutaway view of the outer structure relative to the inner structure at cross-section A-A (FIG. 1) that shows a first flow channel and a second flow channel.

FIG. 3A depicts a perspective view of a separation layer of the inner structure shown in FIGS. 1 and 2.

FIG. 3B is a side cutaway view of an example of a portion of the separation layer shown in FIG. 3A.

FIG. 3C is an expanded view of a portion “B” of the separation layer from the side cutaway view of FIG. 3B.

FIG. 3D is a top view of a portion of the separation layer that shows a distribution of apertures that includes rows and columns of apertures in which the apertures in the rows and columns are linearly aligned with each other.

FIG. 3E is a top view of a portion of the separation layer that shows a distribution of apertures that includes rows and columns of apertures in which the apertures in the rows and columns are offset from each other.

FIG. 3F is another expanded view of the portion “B” of the separation layer from the side cutaway view of FIG. 3B in which portions of the major surface of the separation layer are shaped to improve flow of the feed material.

FIG. 4 depicts a perspective view of the inner structure shown in FIGS. 1 and 2, in which the inner structure includes portions of separation layer and portions of non-porous material.

Throughout the description, similar reference numbers may be used to identify similar elements.

### DESCRIPTION OF EMBODIMENTS OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Biowaste can be generated from various processes. For example, the maintenance of livestock can result in a biowaste that includes water, organic matter, and highly soluble salts. It may be desirable to filter the biowaste to separate the water from the organic matter and the highly soluble salts. While many types of filters exist, the blockage of filter openings (also referred to as “fouling”) is a common problem.

A hydrophilic material is a material that tends to attract water and a hydrophobic material is a material that tends to repel water. It has been realized that a hydrophilic material and a hydrophobic material can be integrated into a separation layer of a filter system to separate a feed material (e.g., a biowaste effluent) into a filtrate portion (e.g., filtered water) and a retentate portion (e.g., a sludge) in a manner that inhibits blockage of filter apertures while being more energy efficient than techniques that involve distillation/vaporization.

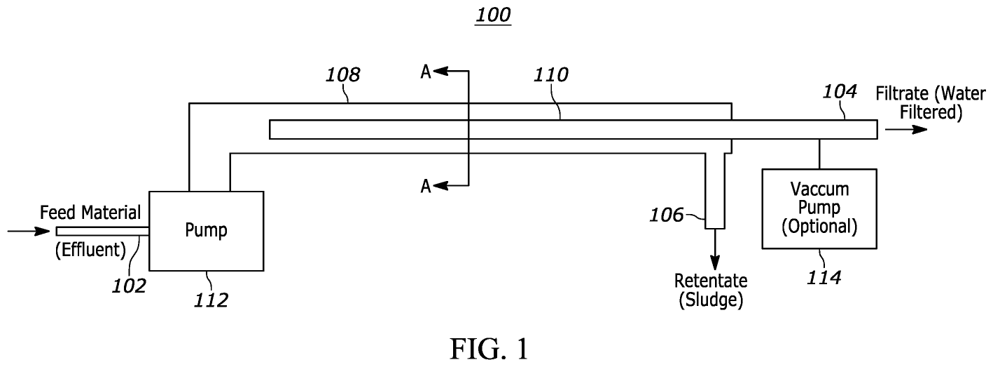

FIG. 1 depicts an example of a filter system 100 that is configured to separate a feed material into a filtrate and a retentate. In an example use case, the feed material is an effluent that results from managing livestock, the filtrate portion of the feed material is filtered water, and the retentate portion of the feed material is a sludge (e.g., a combination of organic material and salts, and NPK, nitrogen, phosphorus, potassium). The filter system 100 of FIG. 1 includes an input 102, a first output 104, a second output 106, an outer structure 108, an inner structure 110, a pump 112, and a vacuum pump 114. In the example of FIG. 1, the input 102 is configured to receive the feed material (e.g., effluent), the first output 104 is configured to output the filtrate portion of the feed material (e.g., filtered water), and the second output 106 is configured to output the retentate portion of the feed material (e.g., sludge). The outer structure 108 provides a channel through which the feed material and retentate can flow and the inner structure 110, which includes a separation layer, provides a channel through which the filtrate can flow. In the embodiment of FIG. 1, the combination of the outer structure 108 and the inner structure 110 form a first flow channel and the inner structure 110 forms a second flow channel.

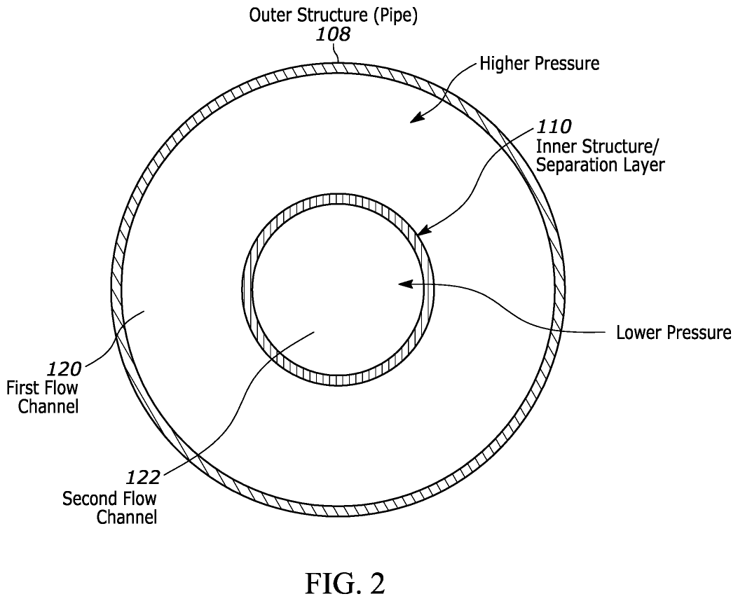

FIG. 2 is a side cutaway view of the outer structure 108 relative to the inner structure 110 at cross-section A-A (FIG. 1) that shows a first flow channel 120 and a second flow channel 122. With reference to both FIGS. 1 and 2, the pump 112 is configured to apply pressure in the first flow channel 120 and the vacuum pump 114 is configured to apply a vacuum in the second flow channel 122. In an example operation, the combination of the pump 112 applying pressure in the first flow channel 120 and the vacuum pump 114 applying a vacuum in the second flow channel 122 facilitates the passage of the filtrate through the separation layer to separate the feed material into a filtrate portion (e.g., filtered water) and a retentate portion (e.g., a sludge). The retentate portion is pumped out of the filter system 100 through the second output 106.

In the embodiment shown in FIGS. 1 and 2, the outer structure 108 and the inner structure 110 are tubular structures that may include, for example, plastic and/or metal pipe. Although the outer structure 108 and inner structure 110 are tubular in the examples of FIGS. 1 and 2, the outer structure 108 and the inner structure 110 may have some other form such as rectangular or some other polygonal or circular shape.

Given a basic layout of the filter system 100 as described with reference to FIGS. 1 and 2, an important element of the filter system is the separation layer of the inner structure 110. In an embodiment, the separation layer includes apertures that allow the filtrate portion of the feed material to pass from a first side of the separation layer to a second side of the separation layer, e.g., from the first flow channel 120 (FIG. 2) to the second flow channel 122 (FIG. 2), while not allowing the retentate portion of the feed material to pass from the first side of the separation layer (e.g., the side facing the first flow channel 120) to the second side of the separation layer (e.g., the side facing the second flow channel 122). Additionally, a hydrophilic material is integrated with the separation layer to promote the passage of the filtrate through the separation layer and a hydrophobic material is integrated with the separation layer to inhibit the retentate from blocking the apertures. That is, the separation layer is designed to promote the passage of the filtrate portion of the feed material (e.g., filtered water) through the apertures while inhibiting blockage of the apertures by the retentate portion of the feed material (e.g., sludge).

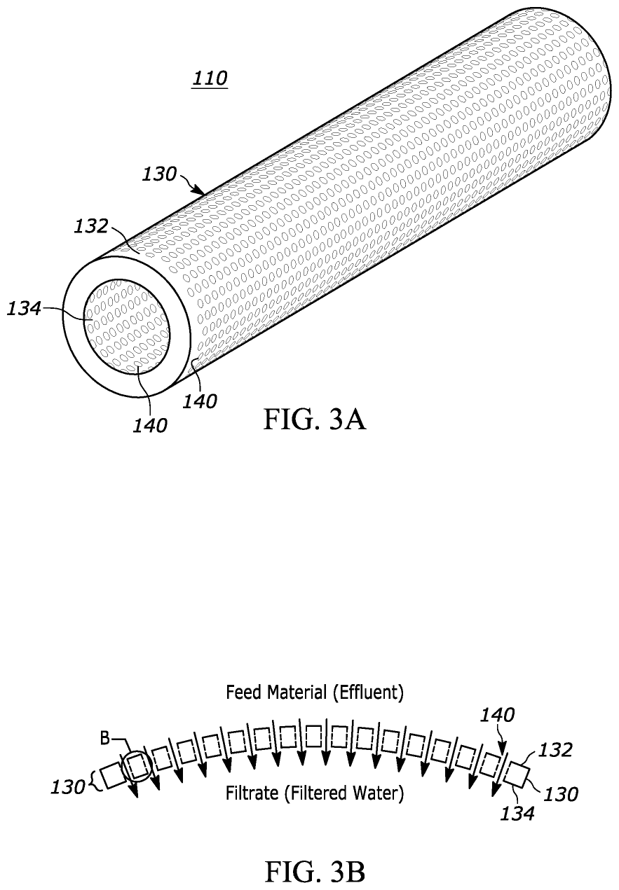

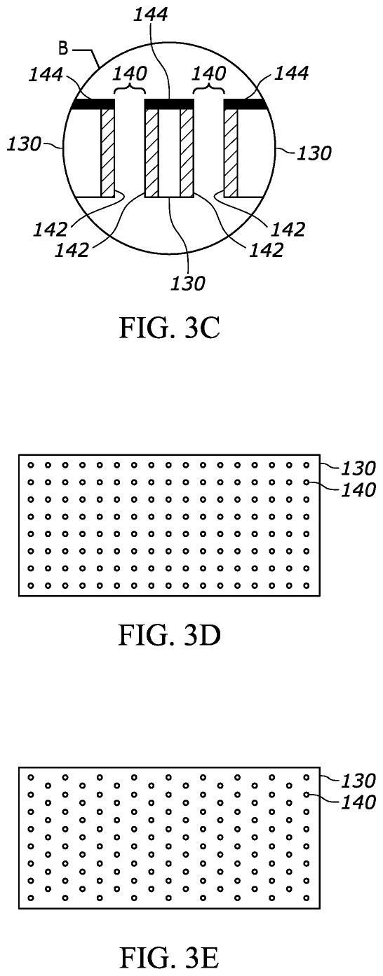

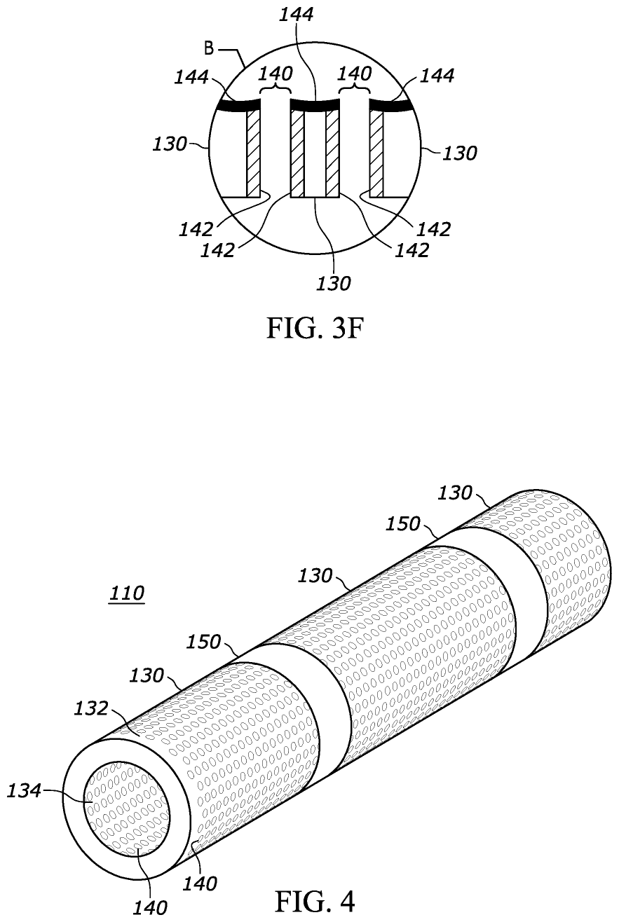

FIGS. 3A-3E depict different views of an example of a separation layer of an inner structure.

FIG. 3A depicts a perspective view of a separation layer 130 of the inner structure 110 shown in FIGS. 1 and 2. The perspective view of FIG. 3A shows the separation layer 130 having a tubular structure with a first major surface 132 and a second major surface 134. In the example of FIG. 3A, in which the separation layer 130 includes a tubular structure, the first major surface 132 of the separation layer 130 is an outer surface of the tubular structure and the second major surface 134 of the separation layer 130 is an inner surface of the tubular structure. FIG. 3A also shows the locations of apertures 140 on the first major surface 132 (e.g., the outer surface) of the tubular structure and the locations of the apertures 140 on the second major surface 134 (e.g., the inner surface) of the tubular structure. The apertures provide passageways through the separation layer 130 from a flow channel that runs adjacent to the first major surface 132 (e.g., outer surface of the tubular structure) to a flow channel that runs adjacent to the second major surface 134 (e.g., the inner surface of the tubular structure).

FIG. 3B is a side cutaway view of an example of a portion of the separation layer 130 shown in FIG. 3A. The side cutaway view of FIG. 3B shows the apertures in the separation layer running from the first major surface 132 (e.g., the outer or “top” surface) at a first side of the separation layer 130 to the second major surface 134 (e.g., the inner or “bottom” surface) at a second side of the separation layer 130. The passage of the filtrate through the apertures 140 from the first side of the separation layer to the second side of the separation layer is illustrated by the downward pointing arrows.

FIG. 3C is an expanded view of a portion “B” of the separation layer 130 from the side cutaway view of FIG. 3B. The expanded view of FIG. 3C shows an example of how a hydrophilic material 142 is integrated with the separation layer 130 to promote the passage of the filtrate portion of the feed material through the apertures 140 from the first side of the separation layer to the second side of the separation layer and an example of how a hydrophobic material 144 is integrated with the first major surface at the first side of the separation layer 130 to inhibit blockage of the apertures 140 by the retentate portion of the feed material. In the example of FIG. 3C, the hydrophilic material 142 is integrated onto sidewalls of the separation layer that form the apertures 140. In the configuration shown in FIG. 3C, the location of the hydrophilic material 142 acts to attract water to the apertures 140 to promote passage of water through the apertures 140 to the second side of the separation layer 130.

In an embodiment, the hydrophilic material 142 is constructed using materials that encourage wetting, around the apertures, while avoiding molecules that repel water. In an embodiment, a front end of the apertures (e.g., at the first major surface 132 of the separation layer 130) contains features to encourage cutting of the water meniscus, and channeling into a molecular sieve at the back end of the separation layer (e.g., at the second major surface of the separation layer), where negative pressure is applied.

In the example of FIG. 3C, the hydrophobic material 144 is integrated onto the first major surface 132 of the separation layer 130. For example, the hydrophobic material 144 covers the area of the first major surface 132 that lies between the apertures 140. In the configuration shown in FIG. 3C, the location of the hydrophobic material on the top major surface of the separation layer acts to repel the feed material from adhering to the surface and ultimately blocking the apertures. For example, the hydrophobic material inhibits sludge from building up on the top surface of the separation layer to such a degree that the apertures 140 eventually are blocked, thereby preventing water from passing through the apertures.

In an embodiment, the hydrophobic material 144 is designed to be charge-neutral, offering no attraction to water molecules, which are normally polarized. The hydrophobic material may also contain elements such as fluorine, which are known to not offer a wetting surface for water as additional repulsion. Using a separation layer with hydrophobic material, a significant part of the separation layer repels water, and along with it, suspended solids that could cause blockage of the apertures.

As shown in FIGS. 3A and 3B, the apertures 140 are distributed throughout the separation layer 130. Various different distribution patterns of the apertures are possible. FIGS. 3D and 3E are top views of portions of the separation layer 130 that have different distribution patterns of apertures 140. In the example of FIGS. 3D and 3E, the separation layer is shown as a flat surface for ease of representation. FIG. 3D shows a distribution of apertures 140 that includes rows and columns of apertures in which the apertures in the rows and columns are linearly aligned with each other and FIG. 3E shows a distribution of apertures that includes rows and columns of apertures in which the apertures in the rows and columns are offset from each other. In an embodiment, the diameter of the apertures is around 2.8 angstrom, ±20%. For example, the apertures are sized so that water molecules can pass through the apertures while other parts of the feed material are too large to pass through the apertures. In other embodiments, the diameters of the apertures are sized at 10 Angstroms or larger to allow salt molecules to pass through the apertures of the separation layer 130, while still holding back larger suspended solids. In an embodiment, the apertures are spaced apart by about 3× their size±20% (e.g., by 3× the diameter of circular apertures, such as a separation distance of 8.4 angstroms). In an embodiment, the apertures cover 1-25% of the area of the separation layer. For example, the apertures make up about 1-25% of the area over a portion of the separation layer and the first and second major surfaces of the separation layer make up the balance, e.g., 75-99%, of the area over a portion of the separation layer. For example, over a 1 inch by 1 inch square section of the separation layer 130 (e.g., from a top view), apertures 140 would make up about 1-25% of the area while the major surface would make up the balance of the area, e.g., 75-99%. Although two examples of distribution patterns of the apertures are shown, other distribution patterns of the apertures are possible. For example, the apertures may be randomly distributed throughout the separation layer.

In an embodiment, a hydrophobic material 144 covers the first major surface 132 of the separation layer. For example, with reference to FIGS. 3B-3E, a hydrophobic material covers the “top” surface of the separation layer 130 over the surface area of the top surface of the separation layer except for the locations of the apertures. In other embodiments, the hydrophobic material may be patterned such that there is no hydrophobic material within a certain distance from the edge of each aperture.

In an embodiment, the separation layer can be formed into sheets, pipes, or contours to maximize surface area. The separation layer may be attached to a frame, either at a sheet level, or at the molecular level, e.g., for adding rigidity that enables the separation layer to withstand a pressure differential.

In an embodiment, the hydrophobic material may include a fluorine-based material and/or a TEFLON based material.

In an embodiment, the separation layer may include a silicon-based material. In an embodiment, the hydrophobic material may include a silicon oxide layer that can be formed on, for example, a silicon substrate.

In the examples of FIGS. 1-3F, the separation layer is tubular in shape. However, other configurations of the separation layer are possible. For example, the separation layer may be planar. In an embodiment, the separation layer is produced in planar sheets. The separation layer may have a thickness in the range of 0.5-1.5 mm, although other thicknesses are possible.

In an embodiment, the apertures may form linear channels that pass straight through the separation layer. In other embodiments, the apertures may have different shapes, including for example non-linear, random, or a combination of different shapes and/or sizes. In an embodiment, the apertures are circular (e.g., from a top view) although other shapes of apertures are possible. For example, the apertures may be rectangular (e.g., from a top view), or the apertures may have other shapes, or a combination of shapes. In an embodiment, the apertures are designed to work at moderate vacuum, such as negative 0.1 ATM.

In an embodiment, the vacuum provided by the vacuum pump may be in the range of 1-15 pounds per square inch absolute (psia) although other pressure ranges are possible.

In an embodiment, the inner structure may have a diameter of approximately 1 inch (±20%) and the outer structure may have a diameter of 2 inches (±20%), with lengths in the range of 5-10 feet. Although an example of dimensions of the inner and outer structures are provided, other dimensions are possible.

In an embodiment, the filter system has a throughput capacity of 1-10 gallons per minute (gpm). Although an example of throughput capacity is provided, other throughput capacities are possible.

In the example of FIGS. 1-3F, the feed material flows in the first flow channel and the filtrate (e.g., filtered water) flows in the second flow channel. In other embodiments, the separation layer may be configured to filter the feed material from the inner surface. That is, the feed material may be fed into the flow channel formed inside the inner structure and the filtrate passes from the inner surface of the inner structure to an outer surface of the inner structure into the flow channel formed between the outer structure 108 and the inner structure 110. For example, with reference to FIGS. 1 and 2, the feed material is pumped into the second flow channel 122 and the filtrate (e.g., the filtered water) is pumped out through the first flow channel 120.

In an embodiment, multiple filter systems may be connected in parallel to increase throughput of the filter system. In another embodiment, multiple filter systems may be connected in series to increase the overall filter separation level. For example, filter systems with separation layers designed for finer level separation may be serially connected to remove a higher degree of non-water elements from the feed material to produce a cleaner filtrate (e.g., a higher level of filtered water).

Although the example filter system 100 of FIG. 1 includes a pump 112 and a vacuum pump 114, other embodiments may include the pump but not the vacuum pump and other embodiments may include the vacuum pump but not the pump. Further, more than one pump and/or vacuum pump may be included in the filter system. Components other than pumps may be used to apply pressure and/or vacuum.

In an embodiment, the apertures are designed to reduce meniscus forces that may be present. For example, the first major surface of the separation layer (e.g., the layer directly adjacent to the feed material) may be contoured to channel the flow of the feed material. In an embodiment, the inner structure and/or the outer structure may include a contoured surface that is designed to improve fluid flow. For example, the inner structure and/or the outer structure may include features such as channels or dimples that enhance fluid flow. In an embodiment, the features are on the surface of the inner structure that is in direct contact with the feed material. FIG. 3F is another expanded view of the portion “B” of the separation layer 130 from the side cutaway view of FIG. 3B in which portions of the major surface of the separation layer are shaped to improve flow of the feed material. For example, portions of the major surface of the separation layer, including the hydrophobic material 144, have curved surfaces to promote fluid flow. In the example of FIG. 3F, portions of the separation layer, including the hydrophobic material, are curved to promote fluid flow. In an embodiment, the features may be designed to create laminar flow or turbulent flow depending on design criteria.

In an embodiment, at least a portion of the inner structure includes a separation layer that is designed to separate the feed material into a filtrate and a retentate. In some embodiments, the separation layer makes up the entire inner structure and in other embodiments, the separation layer makes up only a portion, or portions, of the inner structure. FIG. 4 depicts a perspective view of the inner structure 110 shown in FIGS. 1 and 2, in which the inner structure 110 includes portions of separation layer 130 and portions of non-porous material 150. The perspective view of FIG. 4 shows the inner structure 110 (including both portions of the separation layer 130 and portions of non-porous material 150) having a tubular structure with a first major surface 132 and a second major surface 134. In the example of FIG. 4, the non-porous material 150 may be the same material as the separation layer (but without the apertures 140) or the non-porous material may be a different material, e.g., a material that has more structural integrity.

In an embodiment, the inner structure could be at least in part plastic, ceramic, or some combination of plastic and ceramic. The inner structure may be formed from other materials. In an embodiment, the separation layer of the inner structure is formed from a material (such as, for example, a silicon-based material) that is conducive to forming the apertures and upon which the hydrophobic material and the hydrophilic material may be formed. In an embodiment, the outer structure is formed from plastic or metal.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A filter system comprising:
a separation layer having a plurality of apertures that allow passage of a filtrate portion of a feed material from a first side of the separation layer to a second side of the separation layer;
hydrophilic material integrated with the separation layer to promote the passage of the filtrate portion of the feed material through the plurality of apertures; and
hydrophobic material integrated with the separation layer to inhibit blockage of the plurality of apertures by a retentate portion of the feed material.

2. The filter system of claim 1, wherein the hydrophilic material is located on walls of the apertures.

3. The filter system of claim 1, wherein the hydrophobic material is located on a first major surface at the first side of the separation layer.

4. The filter system of claim 1, wherein the hydrophilic material is located on walls of the apertures and wherein the hydrophobic material is located on a first major surface at the first side of the separation layer.

5. The filter system of claim 1, wherein the plurality of apertures have a diameter of 2.8 angstroms±20%.

6. The filter system of claim 1, wherein the plurality of apertures cover 1-25% of an area of the separation layer.

7. The filter system of claim 1, further comprising a first flow channel through which the feed material flows and a second flow channel through which the filtrate portion of the feed material flows.

8. The filter system of claim 7, further comprising a pump configured to apply pressure in the first flow channel.

9. The filter system of claim 7, further comprising a vacuum pump configured to apply a vacuum in the second flow channel.

10. The filter system of claim 7, further comprising a pump configured to apply pressure in the first flow channel and a vacuum pump configured to apply a vacuum in the second flow channel.

11. The filter system of claim 1, wherein the separation layer is tubular in shape.

12. The filter system of claim 1, wherein the separation layer is planar in shape.

13. A filter system comprising:
a separation layer having a plurality of apertures that allow passage of a filtrate portion of a feed material through the plurality of apertures from a first side of the separation layer to a second side of the separation layer;
hydrophilic material integrated with the plurality of apertures to promote the passage of the filtrate portion of the feed material through the plurality of apertures; and
hydrophobic material integrated with the separation layer on a first major surface at the first side of the separation layer to inhibit blockage of the plurality of apertures by a retentate portion of the feed material.

14. A filter system comprising:
an input to receive a feed material;
outer structure;
inner structure;
a first output to output a filtrate portion of the feed material;
a second output to output a retentate portion of the feed material;
wherein the inner structure includes a separation layer having a plurality of apertures that allow passage of the filtrate portion of the feed material from a first side of the separation layer to a second side of the separation layer;
hydrophilic material integrated with the separation layer to promote the passage of the filtrate portion of the feed material through the plurality of apertures; and
hydrophobic material integrated with the separation layer at the first side of the separation layer to inhibit blockage of the plurality of apertures by a retentate portion of the feed material.

15. The system of claim 14, wherein the hydrophobic material is integrated on a first major surface of the separation layer at the first side of the separation layer.

16. The system of claim 14, wherein the hydrophilic material is integrated on walls of the apertures.

17. The system of claim 14, wherein the hydrophobic material is integrated on a first major surface of the separation layer at the first side of the separation layer and wherein the hydrophilic material is integrated on walls of the apertures.

18. The system of claim 14, wherein the outer structure comprises a pipe.

19. The system of claim 14, wherein the outer structure and the inner structure are tubular shaped.

20. A filter system comprising:
an input to receive a feed material;
a tubular outer structure;
a tubular inner structure;
a first output to output a filtrate portion of the feed material;
a second output to output a retentate portion of the feed material;
wherein the tubular inner structure includes a separation layer having a plurality of apertures that allow passage of the filtrate portion of the feed material from an outer side of the separation layer to an inner side of the separation layer;
hydrophilic material integrated with the separation layer to promote the passage of the filtrate portion of the feed material through the plurality of apertures; and
hydrophobic material integrated with the separation layer at the outer side of the separation layer to inhibit blockage of the plurality of apertures by a retentate portion of the feed material.
